(19) United States
(12) Patent Application Publication
(10) Pub. No.: US 2014/0249799 A1
(43) Pub. Date: Sep. 4, 2014

(54) RELATIONAL SIMILARITY MEASUREMENT

(71) Applicant: MICROSOFT CORPORATION, Redmond, WA (US)

(72) Inventors: Wen-tau Yih, Redmond, WA (US); Geoffrey Zweig, Sammamish, WA (US); Christopher Meek, Kirkland, WA (US); Alisa Zhila, Mexico City (MX); Tomas Mikolov, Mountain View, CA (US)

(73) Assignee: Microsoft Corporation, Redmond, WA (US)

(21) Appl. No.: 13/783,798

(22) Filed: Mar. 4, 2013

(51) Int. Cl. G06F 17/28

(52) U.S. Cl. CPC G06F 17/2881
USPC 704/9

(57) ABSTRACT

Relational similarity measuring embodiments are presented that generally involve creating a relational similarity model that, given two pairs of words, is used to measure a degree of relational similarity between the two relations respectively exhibited by these word pairs. In one exemplary embodiment this involves creating a combined relational similarity model from a plurality of relational similarity models. This is generally accomplished by first selecting a plurality of relational similarity models, each of which measures relational similarity between two pairs of words, and each of which is trained or created using a different method or linguistic/textual resource. The selected models are then combined to form the combined relational similarity model. The combined model inputs two pairs of words and outputs a relational similarity indicator representing a measure the degree of relational similarity between the word pairs.

### BACKGROUND

Measuring relational similarity between two word pairs involves determining the degree to which the inter-word relation exhibited by one word pair matches the relation exhibited by the other word pair. For instance, the analogous word pairs “silverware:fork” and “clothing:shirt” both exemplify “a type of” relation and as such would have a high relational similarity.

Knowing the relational similarity between two word pairs has many potential applications. For instance, the relational similarity between two word pairs can be compared to the relational similarity between prototypical word pairs having a desired relationship to identify specific relations between words, such as synonyms, antonyms or other associations. Further, identifying the existence of certain relations is often a core problem in information extraction or question answering applications. Measuring relational similarity between two word pairs can be used to accomplish this task. For example, in a question-answer scenario, the relation between keywords in a question can be compared to the relation between keywords in various answers. The answer or answers having a close relational similarity to the question would be selected to respond to the question. In yet another example, a student would be presented with a word pair having a particular relation between its words and asked to provide a different word pair having a similar relation between its words. Measuring the relational similarity between the given word pair and the student's answer provides a way to assess the student's proficiency.

### SUMMARY

Relational similarity measuring embodiments described herein generally involve creating a relational similarity model that given pairs of words, measures a degree of relational similarity between the relations respectively exhibited by these word pairs. In one exemplary embodiment this involves creating a combined relational similarity model from a plurality of individual relational similarity models. This is generally accomplished by first selecting a plurality of relational similarity models, each of which measures relational similarity between two pairs of words, and each of which is trained or created using a different method or linguistic/textual resource. The selected models are then combined to form the combined relational similarity model. The combined model inputs two pairs of words and outputs a relational similarity indicator representing a measure the degree of relational similarity between the word pairs.

In another exemplary embodiment, measuring the degree of relational similarity between two pairs of words involves first inputting a pre-trained semantic vector space model, where each word associated with the model is represented as a real-valued vector. The pre-trained semantic vector space model is then applied to each of the words of each word pair to produce a real-valued vector for each word. Next, for each word pair, a difference is computed between the real-valued vector of the second word of the word pair and the real-valued vector of the first word of the word pair to produce a directional vector. A directional similarity score is computed using the directional vectors of the two word pairs, and this directional similarity score is designated as the measure of the degree of relational similarity between the two word pairs.

It should be noted that the foregoing Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

The specific features, aspects, and advantages of the disclosure will become better understood with regard to the following description, appended claims, and accompanying drawings where:

FIG. 1 is a flow diagram generally outlining one embodiment of a process for measuring the degree of relational similarity between two pairs of words using a directional similarity model.

FIG. 2 is a flow diagram generally outlining one embodiment of a process for measuring the degree of relational similarity between two pairs of words using a lexical pattern model.

FIG. 3 is a flow diagram generally outlining one embodiment of a process for creating a combined relational similarity model for use in measuring the degree of relational similarity between two pairs of words.

FIG. 4 is a flow diagram generally outlining an implementation of the part of the process of FIG. 3 involving combining selected relational similarity models.

FIG. 5 is a flow diagram generally outlining one embodiment of a process for using the combined relational similarity model to measure the degree of relational similarity between two pairs of words.

FIG. 6 is a flow diagram generally outlining one embodiment of a process for measuring the degree of correspondence between the relation exhibited by one word pair having an unknown relation between the words thereof and a plurality of word pairs that each exhibit the same known relation between the words.

FIG. 7 is a flow diagram generally outlining one embodiment of a process for measuring the degree of correspondence between the relation exhibited by one word pair having an unknown relation between the words thereof and a relational similarity standard representing a known relation between words of a word pair.

FIG. 8 is a flow diagram generally outlining an implementation of the part of the process of FIG. 7 involving the creation of a relational similarity standard.

FIG. 9 is a flow diagram generally outlining an implementation of the part of the process of FIG. 7 involving the application of the relational similarity standard model to the inputted word pair to produce a relational similarity indicator.

FIG. 10 is a diagram depicting a general purpose computing device constituting an exemplary system for implementing relational similarity measuring embodiments described herein.

### DETAILED DESCRIPTION

In the following description of relational similarity measuring embodiments reference is made to the accompanying drawings which form a part hereof, and in which are shown, by way of illustration, specific embodiments in which the technique may be practiced. It is understood that other embodiments may be utilized and structural changes may be made without departing from the scope of the technique.

It is also noted that for the sake of clarity specific terminology will be resorted to in describing the relational similarity measuring embodiments described herein and it is not intended for these embodiments to be limited to the specific terms so chosen. Furthermore, it is to be understood that each specific term includes all its technical equivalents that operate in a broadly similar manner to achieve a similar purpose. Reference herein to “one embodiment”, or “another embodiment”, or an “exemplary embodiment”, or an “alternate embodiment”, or “one implementation”, or “another implementation”, or an “exemplary implementation”, or an “alternate implementation” means that a particular feature, a particular structure, or particular characteristics described in connection with the embodiment or implementation can be included in at least one embodiment of relational similarity measuring. The appearances of the phrases “in one embodiment”, “in another embodiment”, “in an exemplary embodiment”, “in an alternate embodiment”, “in one implementation”, “in another implementation”, “in an exemplary implementation”, “in an alternate implementation” in various places in the specification are not necessarily all referring to the same embodiment or implementation, nor are separate or alternative embodiments/implementations mutually exclusive of other embodiments/implementations. Yet furthermore, the order of process flow representing one or more embodiments or implementations of relational similarity measuring does not inherently indicate any particular order nor imply any limitations thereof.

### 1.0 Relational Similarity Measuring

Relational similarity measuring embodiments described herein generally measure the degree of correspondence between word pairs. In one embodiment, the relational similarity measuring is accomplished using a general-purpose relational similarity model derived using directional similarity, and in another embodiment this is accomplished using a general-purpose relational similarity model learned from lexical patterns. Operating in a word vector space, the directional similarity model compares the vector differences of word pairs to estimate their relational similarity. The lexical pattern method collects contextual information of pairs of words when they co-occur in large corpora, and learns a highly regularized log-linear model. In yet other embodiments, relational similarity measuring involves combining models based on different information sources. This can include using either the aforementioned directional similarity or lexical pattern models, or both. Finally, it has been found that including specific word-relation models, such as IsA and synonymy/antonymy, tends to make the final relational similarity measure more robust even though they tend to cover a smaller number of relations. In one embodiment involving the aforementioned combination of models, the results obtained from the models are combined with weights learned using logistic regression.

### 1.1 Directional Similarity Model

The directional similarity model extends semantic word vector representations to a directional semantics for pairs of words. Operating in a word vector space, the directional similarity model compares the vector differences of two word pairs to estimate their relational similarity.

Let ωᵢ=(wᵢ_{₁}, wᵢ_{₂}) and ωⱼ=(wⱼ_{₁}, wⱼ_{₂}) be the two word pairs being compared. Suppose (\vec{ν}ᵢ_{₁}, \vec{ν}ᵢ_{₂}) and (\vec{ν}ⱼ_{₁}, \vec{ν}ⱼ_{₂}) are the corresponding vectors of these words. The directional vectors of ωᵢ and ωⱼ are defined as \vec{ν}ᵢ≡\vec{ν}ᵢ_{₁}−\vec{ν}ᵢ_{₂}, and \vec{ν}ⱼ≡\vec{ν}ⱼ_{₁}−\vec{ν}ⱼ_{₂}, respectively. Relational similarity of these two word pairs can be measured by a distance function of νᵢ and νⱼ, such as the cosine function:

$$\frac{{\vec{υ}}_{i} \cdot {\vec{υ}}_{j}}{‖ {\vec{υ}}_{i} ‖ ‖ {\vec{υ}}_{j} ‖} \qquad ( 1 )$$

Because the difference of two word vectors reveals the change from one word to the other in terms of multiple topicality dimensions in the vector space, two word pairs having similar offsets (i.e., being relatively parallel) can be interpreted as they have similar relations.

It is noted that the quality of the directional similarity model depends in part on the underlying word vector space model. There are many different methods for creating real-valued semantic word vectors, such as the distributed representation derived from a word co-occurrence matrix and a low-rank approximation, latent semantic analysis (LSA), word clustering and neural-network language modeling (including recurrent neural network language modeling (RNNLM)). Each element in the vectors conceptually represents some latent topicality information of the word. The gist of these methods is that words with similar meanings will tend to be close to each other in the vector space. It is noted that while any of the foregoing vector types (or their like) can be employed, in one tested embodiment, 1600-dimensional vectors from a RNNLM vector space trained using a broadcast news corpus of 320M words, were employed with success.

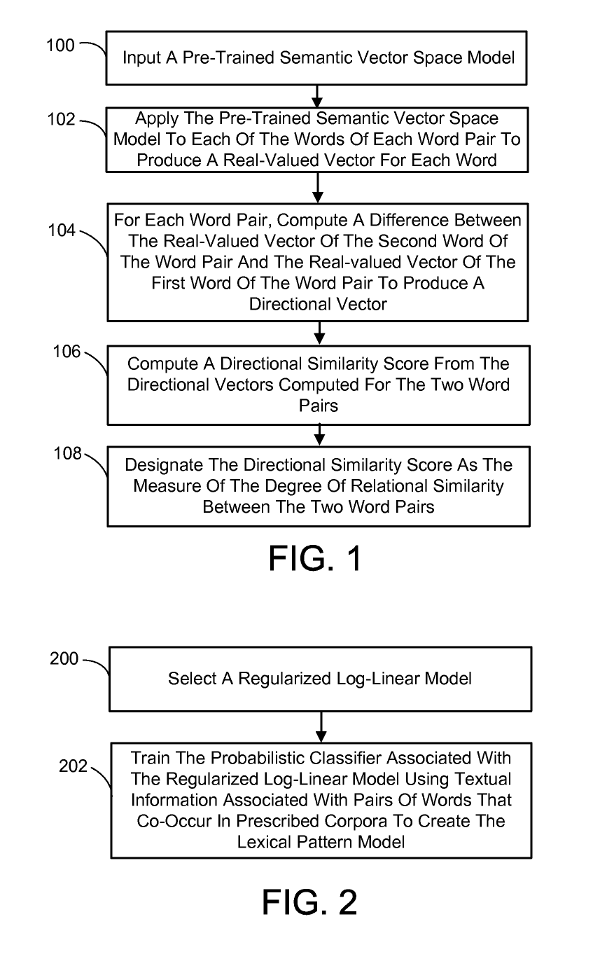

The foregoing aspects of the directional similarity model can be realized in one general implementation outlined in FIG. 1. More particularly, a computing device is used to measure the degree of relational similarity between two pairs of words, where each pair exhibits a semantic or syntactic relation between the words thereof. This involves first inputting a pre-trained semantic vector space model (process action 100). It is noted that each word associated with the model is represented as a real-valued vector. The pre-trained semantic vector space model is then applied to each of the words of each word pair to produce a real-valued vector for each word (process action 102). Then, for each word pair, a difference is computed between the real-valued vector of the second word of the word pair and the real-valued vector of the first word of the word pair to produce a directional vector for that pair (process action 104). The directional vectors computed for the two word pairs are then used to compute a directional similarity score (process action 106). This directional similarity score is designated as the aforementioned measure of the degree of relational similarity between the two word pairs (process action 108). In one embodiment, as indicated previously, computing the directional similarity score is accomplished by computing a distance measure between the relational similarity vectors produced for the two word pairs.

### 1.2 Lexical Pattern Model

The lexical pattern model for measuring relational similarity is built based on lexical patterns. It is well-known that contexts in which two words co-occur often provide useful cues for identifying a word relation. For example, having observed frequent text fragments like “X such as Y”, it is likely that there is a relation between X and Y; namely Y is a type of X. Thus, the lexical pattern model is generally created by collecting contextual information of pairs of words when they co-occur in large corpora. This is then followed by learning a highly regularized log-linear model from the collected information.

In order to find more co-occurrences of each pair of words, a large document set is employed, such as the Gigaword corpus, or Wikipedia, or the Los Angeles Times articles corpus. Any combination of big corpora can also be employed. For each word pair (w₁, w₂) that co-occur in a sentence, the words in between are collected as its context (or so-called “raw pattern”). For instance, “such as” would be the context extracted from “X such as Y” for the word pair (X, Y). To reduce noise, in one embodiment contexts with more than nine words are dropped.

Treating each raw pattern as a feature where the value is logarithm of the occurrence count, a probabilistic classifier is built to determine the association of the context and relation. For each relation, all its word pairs are treated as positive examples and all the word pairs in other relations as negative examples in training the classifier. The degree of relational similarity of each word pair can then be judged by the output of the corresponding classifier.

It is noted however that using a large number of features and examples can cause the model to overfit if not regularized properly. In view of this, in one embodiment instead of employing explicit feature selection methods, an efficient L₁ regularized log-linear model learner is used and the hyper-parameters are chosen based on model performance on training data. In one tested implementation, the final models were successfully trained with L₁=3.

The foregoing aspects of the lexical pattern model can be realized in one general implementation outlined in FIG. 2. First, a regularized log-linear model is selected (process action 200). A probabilistic classifier associated with the regularized log-linear model is then trained using textual information associated with pairs of words that co-occur in prescribed corpora, to create the lexical pattern model (process action 202). As indicated previously, in one embodiment, the textual information takes the form of textual patterns of words found between the words of the co-occurring word pair. Further, in one embodiment, the probabilistic classifier is trained with the textual patterns as features using a logistic regression procedure.

### 1.3 Combined Model

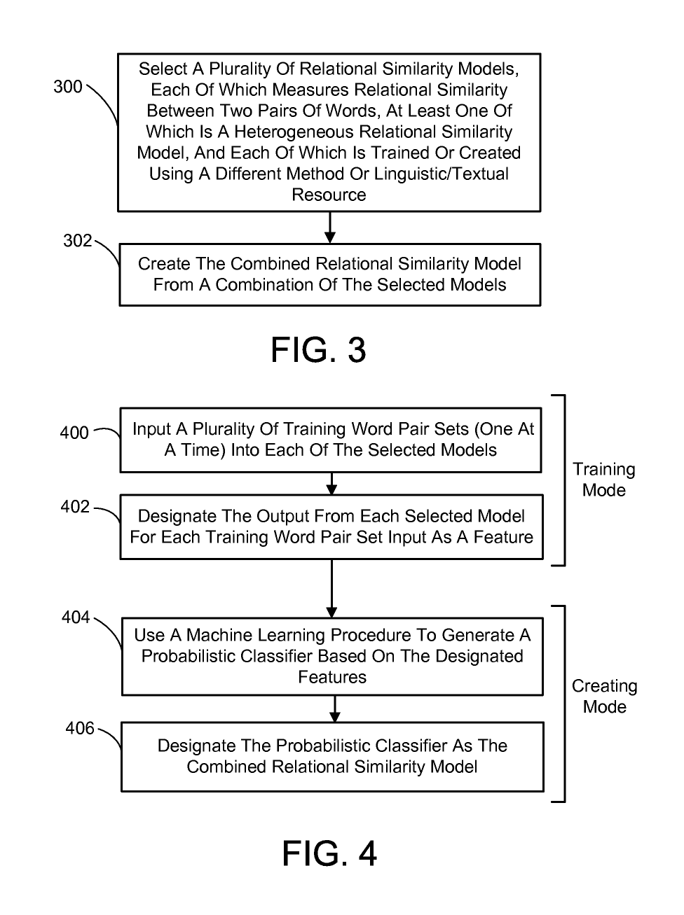

The combined model approach generally involves computing a combination of the individual models employed. One general implementation of this approach is outlined in FIG. 3. More particularly, a computing device is used to create a combined relational similarity model that given two pairs of words (each of which exhibits a semantic or syntactic relation between the words of the word pair) is used to measure a degree of similarity between the two relations respectively exhibited by the word pairs. This involves first selecting a plurality of relational similarity models, each of which measures relational similarity between two pairs of words, at least one of which is a heterogeneous relational similarity model, and each of which is trained or created using a different method or linguistic/textual resource (process action 300). The combined relational similarity model is then created from a combination of the selected models (process action 302). This combined relational similarity model inputs two pairs of words and outputs a relational similarity indicator representing a measure the degree of relational similarity between the inputted word pairs.

With regard to combining the selected relational similarity models, in one embodiment outlined in FIG. 4 this involves an initial training mode followed by a creating mode. In the training mode, a plurality of training word pair sets are input (one at a time) into each of the selected models (process action 400). Each training word pair set is made up of two pairs of words, each pair of which exhibits a known semantic or syntactic relation between the words of the pair. The output from each selected model for each training word pair set input is designated as a feature (process action 402). Then, in the creating mode, a machine learning procedure is used to generate a probabilistic classifier based on the designated features (process action 404). This probabilistic classifier is designated as the aforementioned combined relational similarity model (process action 406).

In one embodiment, using a machine learning procedure to generate the probabilistic classifier involves using a logistic regression procedure to establish a weight for each of the selected models. In this embodiment, the probabilistic classifier can be viewed as a weighted combination of the selected models. And in one specific implementation, the classifier represents a linear weighted combination of the selected models.

In another embodiment, using a machine learning procedure to generate the probabilistic classifier involves using a boosted decision trees procedure to establish a weight for each of the selected models. Here again, the probabilistic classifier can be viewed as a weighted combination of the selected models, and in one specific implementation, a linear weighted combination of the selected models.

It is further noted that the previously-described directional similarity and lexical pattern models can be viewed as general purpose heterogeneous relational similarity models as they do not differentiate the specific relation categories. This is in contrast to specific word relation models. While specific word relation models are designed for detecting specific relations between words in a pair, incorporating them into the combined model can improve the overall results. In general, this would be accomplished by applying a specific word relation model to each word pair to obtain a measure of the degree to which the words in the word pair exhibit the specific word relation the model detects. These measures obtained for both word pairs are then compared to produce a measure of the degree to which each word pair exhibits or doesn't exhibit the specific word relation the model detects. For example, if the specific word relation model detects synonyms, and both word pairs exhibit this relation, then the measure produced would indicate the relation exhibited by each pair is similar (i.e. both represent a word pairs in which the words are synonyms).

Examples of specific word relation models that can be employed include information encoded in a knowledge base (e.g., currently available lexical and knowledge databases such as WordNet's Is-A taxonomy, the Never-Ending Language Learning (NELL) knowledge base, and the Probase knowledge base). In addition, lexical semantics models such as the polarity-inducing latent semantic analysis (PILSA) model, which specifically estimates the degree of synonymy and antonymy, can be employed. This latter model first forms a signed co-occurrence matrix using synonyms and antonyms in a thesaurus and then generalizes it using a low-rank approximation derived by singular value decomposition (SVD). Given two words, the cosine score of their PILSA vectors tend to be negative if they are antonymous and positive if synonymous.

In view of the foregoing, it is evident that the combined relational similarity model can be made up of two or more different heterogeneous relational similarity models; or two or more different specific word relation models; or a combination of one or more different heterogeneous relational similarity models and one or more different specific word relation models. However, in one embodiment, each of these models is trained or created using a different method or linguistic/textual resource.

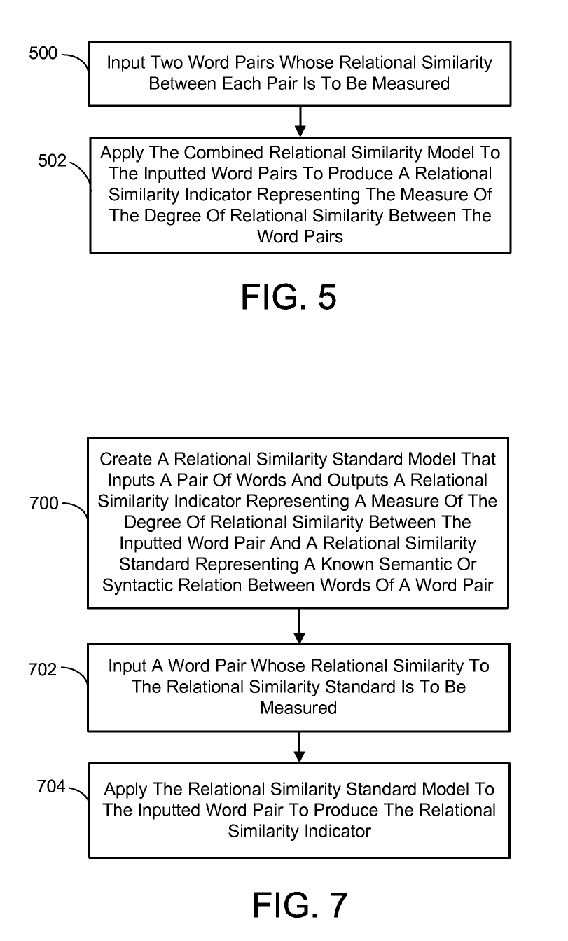

Once the combined relational similarity model is created, it is used to measure the degree of relational similarity between two pairs of words, which each exhibit a semantic or syntactic relation between the words of the pair. The semantic or syntactic relation exhibited by one of the word pairs can be similar or quite different from the relation exhibited by the other word pair. The measure being computed quantifies the closeness of the relations associated with the two word pairs. More particularly, referring to FIG. 5, two word pairs whose relational similarity between each pair is to be measured are input to a computing device (process action 500). The combined relational similarity model is then applied to the inputted word pairs to produce a relational similarity indicator representing the measure of the degree of relational similarity between the word pairs (process action 502).

### 1.4 Relational Similarity Standard Model

The relational similarity measuring embodiments described so far measure the degree of correspondence between two word pairs. In this section, the application of relational similarity measures for identifying a specific word relation is described. Generally, in one embodiment, this involves measuring the degree of correspondence between the relation exhibited by one word pair having an unknown relation between the words thereof and a plurality of word pairs that each exhibit the same known relation between the words. In another embodiment, the degree of correspondence is measured between the relation exhibited by one word pair having an unknown relation between the words thereof and a relational similarity standard representing a known relation between words of a word pair.

With regard to the embodiment of relational similarity measuring that involves measuring the degree of correspondence between the relation exhibited by one word pair having an unknown relation between the words thereof and a plurality of word pairs that each exhibit the same known relation between the words, consider the following example. Suppose 100 example word pairs of the same specific relation are input (e.g., relative/superlative, or class-inclusion, or so on), and it is desired to determine if a new word pair also has the same specific relation as the example word pairs. In one embodiment, this is generally accomplished by using one of the previously-described relational similarity models (including the combine model) to compute a relational similarity measure between the new word pair and each of the 100 example pairs. The computed measures are then combined (e.g., averaged) and used as the relational similarity measure indicating whether the new word pair has the same specific relation as the example pairs.

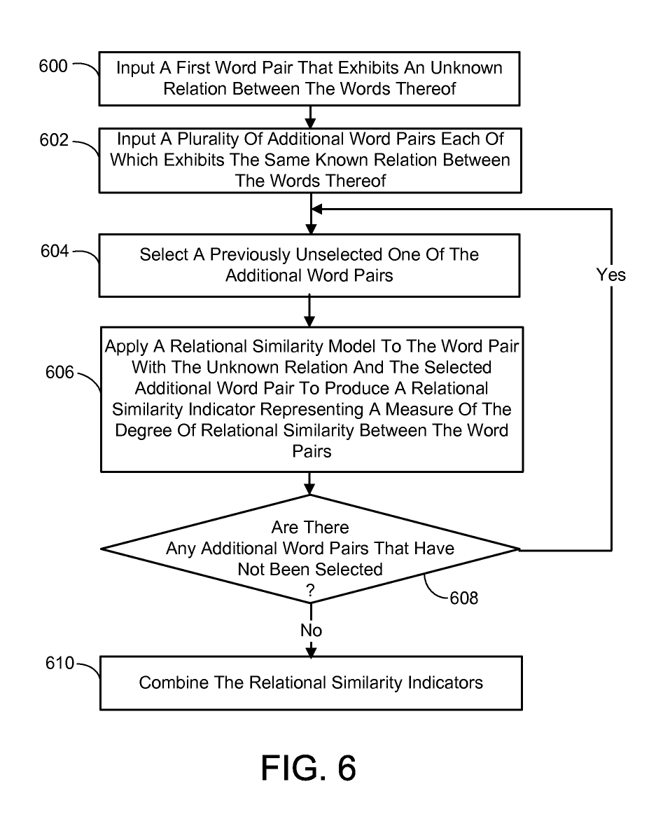

More particularly, referring to FIG. 6, a first word pair that exhibits an unknown relation between the words thereof is input into a computing device (process action 600). In addition, a plurality of additional word pairs each of which exhibits the same known relation between the words thereof are input (process action 602), and a previously unselected one of these additional word pairs is selected (process action 604). A relational similarity model (such as the previously-described combined model) is then applied to the word pair with the unknown relation and the selected additional word pair to produce a relational similarity indicator representing a measure of the degree of relational similarity between these word pairs (process action 606). It is then determined if there are any of the additional word pairs that have not been selected and processed (process action 608). If there are remaining additional word pairs, then process actions 604 and 608 are repeated. When all the additional word pairs have been selected and processed, the relational similarity indicators produced thereby are combined (process action 610). In one implementation, combining the relational similarity indicators involves averaging them. The combined relational similarity indicators are then designated as the measure of the degree of relational similarity between the relation exhibited by the word pair having the unknown relation between its words and the relation exhibited by the plurality of additional word pairs.

It is noted that many of the relations between words in a word pair are common enough to be considered standard relations. This is especially clear for syntactic relations. Take for example the relative/superlative relation for adjectives (e.g., faster/fastest, stronger/strongest, and so on). This relation, as well as many others, is common enough to be considered standard. Given this, it is possible to create a relational similarity standard representing a known relation between words of a word pair. In such an embodiment, the degree of correspondence is measured between the relation exhibited by a word pair having an unknown relation between the words thereof and the relational similarity standard.

More particularly, referring to FIG. 7, a relational similarity standard model is created that inputs a pair of words and outputs a relational similarity indicator representing a measure of the degree of relational similarity between the inputted word pair and a relational similarity standard representing a known semantic or syntactic relation between words of a word pair (process action 700). A word pair whose relational similarity to the relational similarity standard is to be measured is then input (process action 702). The relational similarity standard model is applied to the inputted word pair to produce the aforementioned relational similarity indicator (process action 704).

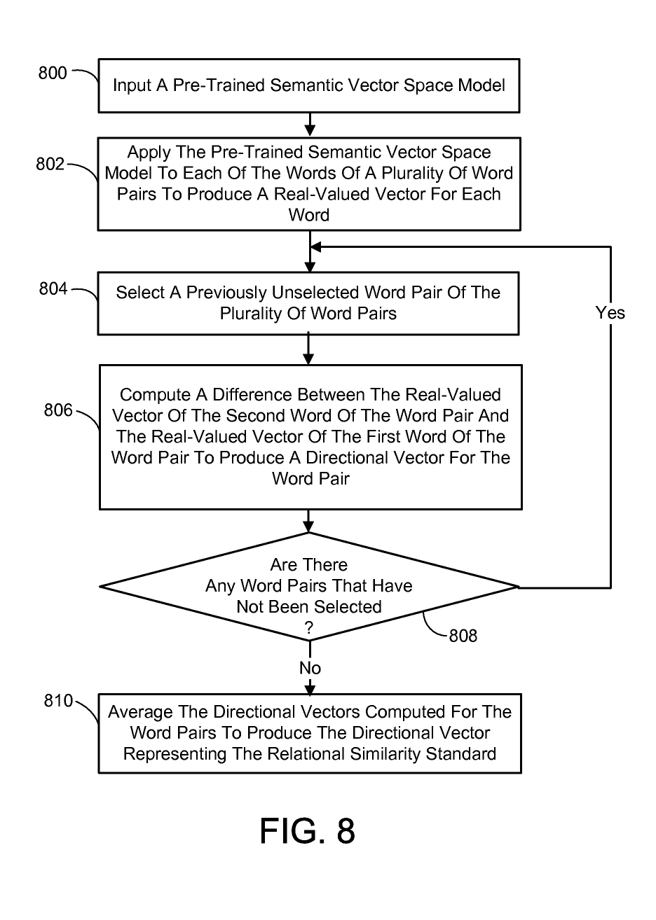

In one implementation, creating a relational similarity standard model involves creating a heterogeneous directional similarity standard model. This model operates in a word vector space and computes a distance between a directional vector computed for the word pair using the word vector space and a directional vector representing the relational similarity standard to estimate the relational similarity. Referring to FIG. 8, in one embodiment creating the directional vector representing the relational similarity standard is accomplished as follows. First, a pre-trained semantic vector space model is input (process action 800). In this model, each word associated with the model is represented as a real-valued vector. Next, the pre-trained semantic vector space model is applied to each of the words of a plurality of word pairs to produce a real-valued vector for each word (process action 802). Each of the plurality of word pairs exhibits a known relation between the words thereof corresponding to the known relation that will be represented by the relational similarity standard being created. A previously unselected word pair of the plurality of word pairs is then selected (process action 804), and a difference is computed between the real-valued vector of the second word of the word pair and the real-valued vector of the first word of the word pair to produce a directional vector for the word pair (process action 806). It is then determined if there are any word pairs that have not been selected and processed (process action 808). If there are unselected word pairs, then process actions 804 and 808 are repeated. Once all the word pairs have been selected and processed, the directional vectors computed for the word pairs are averaged to produce the directional vector representing the relational similarity standard (process action 810).

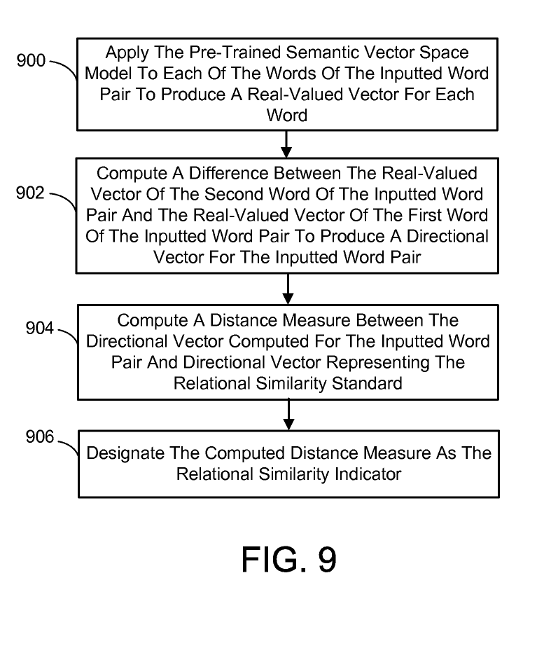

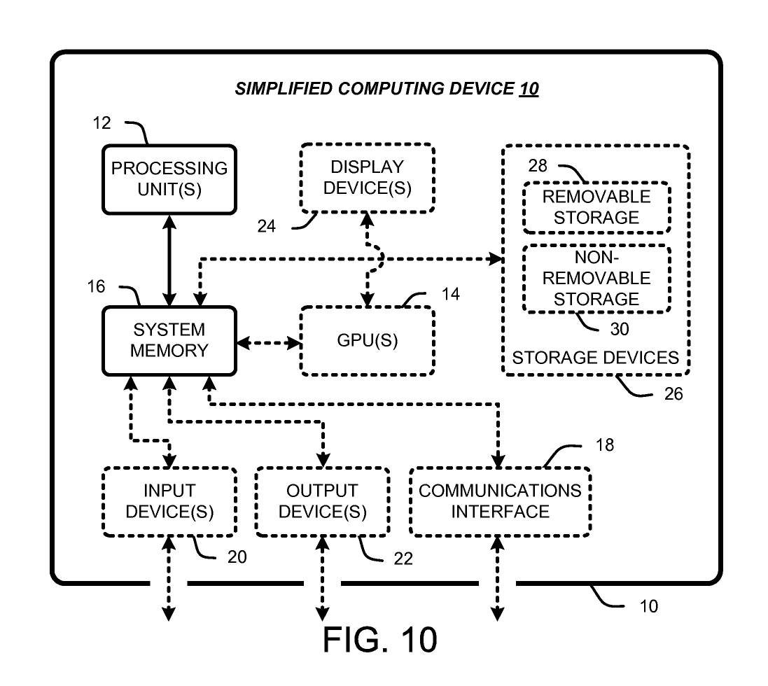

With regard to applying the relational similarity standard model to the inputted word pair to produce the aforementioned relational similarity indicator, in one embodiment, this is accomplished as follows. Referring to FIG. 9, the pre-trained semantic vector space model is applied to each of the words of the inputted word pair, whose relational similarity to the relational similarity standard is to be measured, to produce a real-valued vector for each word (process action 900). A difference is then computed between the real-valued vector of the second word of the inputted word pair and the real-valued vector of the first word of the inputted word pair to produce a directional vector for the inputted word pair (process action 902). Next, a distance measure is computed between the directional vector computed for the inputted word pair and directional vector representing the relational similarity standard (process action 904). This computed distance measure is designated as the relational similarity indicator (process action 906).

### 2.0 Exemplary Operating Environments

The relational similarity measuring embodiments described herein are operational within numerous types of general purpose or special purpose computing system environments or configurations. FIG. 10 illustrates a simplified example of a general-purpose computer system on which various embodiments and elements of the relational similarity measuring embodiments, as described herein, may be implemented. It should be noted that any boxes that are represented by broken or dashed lines in FIG. 10 represent alternate embodiments of the simplified computing device, and that any or all of these alternate embodiments, as described below, may be used in combination with other alternate embodiments that are described throughout this document.

For example, FIG. 10 shows a general system diagram showing a simplified computing device 10. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a device to implement the relational similarity measuring embodiments described herein, the device should have a sufficient computational capability and system memory to enable basic computational operations. In particular, as illustrated by FIG. 10, the computational capability is generally illustrated by one or more processing unit(s) 12, and may also include one or more GPUs 14, either or both in communication with system memory 16. Note that that the processing unit(s) 12 of the general computing device may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 10 may also include other components, such as, for example, a communications interface 18. The simplified computing device of FIG. 10 may also include one or more conventional computer input devices 20 (e.g., pointing devices, keyboards, audio input devices, video input devices, haptic input devices, devices for receiving wired or wireless data transmissions, etc.). The simplified computing device of FIG. 10 may also include other optional components, such as, for example, one or more conventional display device(s) 24 and other computer output devices 22 (e.g., audio output devices, video output devices, devices for transmitting wired or wireless data transmissions, etc.). Note that typical communications interfaces 18, input devices 20, output devices 22, and storage devices 26 for general-purpose computers are well known to those skilled in the art, and will not be described in detail herein.

The simplified computing device of FIG. 10 may also include a variety of computer readable media. Computer readable media can be any available media that can be accessed by computer 10 via storage devices 26 and includes both volatile and nonvolatile media that is either removable 28 and/or non-removable 30, for storage of information such as computer-readable or computer-executable instructions, data structures, program modules, or other data. By way of example, and not limitation, computer readable media may comprise computer storage media and communication media. Computer storage media includes, but is not limited to, computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Retention of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer to a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying some or all of the various relational similarity measuring embodiments described herein, or portions thereof, may be stored, received, transmitted, or read from any desired combination of computer or machine readable media or storage devices and communication media in the form of computer executable instructions or other data structures.

Finally, the relational similarity measuring embodiments described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

### 3.0 Other Embodiments

It is noted that any or all of the aforementioned embodiments throughout the description may be used in any combination desired to form additional hybrid embodiments. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Wherefore, what is claimed is:

1. A computer-implemented process for measuring the degree of relational similarity between pairs of words, each pair of which exhibits a semantic or syntactic relation between the words of the word pair, comprising:
using a computer to perform the following process actions:
selecting a plurality of relational similarity models, each of which measures relational similarity between two pairs of words, at least one of which is a heterogeneous relational similarity model, and each model of which is trained or created using a different method or linguistic/textual resource;
creating a combined relational similarity model from a combination of the selected models that inputs two pairs of words and outputs a relational similarity indicator representing a measure the degree of relational similarity between the inputted word pairs;
inputting two word pairs whose relational similarity between each pair is to be measured; and
applying the combined relational similarity model to the inputted word pairs to produce said relational similarity indicator representing a measure of the degree of relational similarity between the inputted word pairs.

2. The process of claim 1, wherein the process action of selecting a plurality of relational similarity models, comprises selecting a heterogeneous directional similarity model, which operates in a word vector space and computes a distance between directional vectors computed for the word pairs using the word vector space, to estimate their relational similarity.

3. The process of claim 1, wherein the process action of selecting a plurality of relational similarity models, comprises selecting a heterogeneous lexical pattern model which measures relational similarity between two pairs of words using a probabilistic classifier trained on lexical patterns.

4. The process of claim 3, wherein the process action of selecting a lexical pattern model which measures relational similarity between two pairs of words using a probabilistic classifier trained on lexical patterns, comprises selecting a regularized log-linear model comprising a probabilistic classifier that was trained using textual information associated with pairs of words that co-occur in prescribed corpora.

5. The process of claim 1, wherein the process action of selecting a plurality of relational similarity models, comprises selecting one or more specific word relation models associated with lexical databases or knowledge bases that cover specific word relations.

6. The process of claim 1, wherein the process action of selecting a plurality of relational similarity models, comprises selecting one or more lexical semantics models that cover specific word relations.

7. The process of claim 6, wherein said lexical semantics models that cover specific word relations comprise a polarity-inducing latent semantic analysis (PILSA) model.

8. The process of claim 1, wherein the process action of creating said combined relational similarity model from a combination of the selected models, comprises the process actions of:
in a training mode,
inputting a plurality of training word pair sets, one at a time, into each of the selected models, each training word pair set comprising two pairs of words each exhibiting a known semantic or syntactic relation between the words of the pair, and
for each training word pair set input, designating the output from each selected model as a feature; and
in a creating mode,
using a machine learning procedure to generate a probabilistic classifier based on the features, and
designating the probabilistic classifier to be said combined relational similarity model.

9. The process of claim 8, wherein the process action of using a machine learning procedure to generate a probabilistic classifier based on the features, comprises using a logistic regression procedure to establish a weight for each of the selected models, and generating the probabilistic classifier as a weighted combination of the selected models.

10. The process of claim 8, wherein the process action of using a machine learning procedure to generate a probabilistic classifier based on the features, comprises using a boosted decision trees procedure to establish a weight for each of the selected models, and generating the probabilistic classifier as a weighted combination of the selected models.

11. The process of claim 1, wherein a first word pair of said two word pairs exhibits an unknown relation between the words thereof and the second word pair of said two word pairs exhibits a known relation between the words thereof, said process further comprising the process actions of:
(a) inputting an additional word pair that exhibits the same known relation between the words thereof as said second word pair;
(b) applying the combined relational similarity model to the last-inputted word pair and said first word pair to produce a relational similarity indicator representing a measure of the degree of relational similarity between the additional and first word pairs;
(c) repeating process actions (a) and (b) for each of a prescribed number of additional word pairs each of which is different from previously-input additional word pairs, but each of which exhibits the same known relation between the words thereof as said second word pair;
(d) combining the relational similarity indicators produced; and
(e) designating the combined relational similarity indicators to be a measure of the degree of relational similarity between the relation exhibited by the first word pair and the relation exhibited by the second and each additional word pair.

12. The process of claim 11, wherein the process action of combining the relational similarity indicators produced, comprises an action of averaging the relational similarity indicators produced.

13. A computer-implemented process for measuring the degree of relational similarity of a pair of words, which exhibits a semantic or syntactic relation between the words of the word pair, to a relational similarity standard representing a known relation between words of a word pair, comprising:
using a computer to perform the following process actions:
creating a relational similarity standard model that inputs a pair of words and outputs a relational similarity indicator representing a measure of the degree of relational similarity between the inputted word pair and a relational similarity standard representing a known semantic or syntactic relation between words of a word pair;
inputting a word pair whose relational similarity to the relational similarity standard is to be measured; and
applying the relational similarity standard model to the inputted word pair to produce said relational similarity indicator.

14. The process of claim 13, wherein the process action of creating a relational similarity standard model, comprises creating a heterogeneous directional similarity standard model, which operates in a word vector space and computes a distance between a directional vector computed for the word pair using the word vector space and a directional vector representing said relational similarity standard, to estimate the relational similarity.

15. The process of claim 14, wherein the process action of creating a heterogeneous directional similarity standard model, comprises the actions of:
inputting a pre-trained semantic vector space model, where each word associated with the model is represented as a real-valued vector;
applying the pre-trained semantic vector space model to each of the words of a plurality of word pairs each pair of which exhibits a known relation between words of a word pair corresponding to the known relation represented by said relational similarity standard, to produce a real-valued vector for each word;
for each word pair of said plurality of word pairs, computing a difference between the real-valued vector of the second word of the word pair and the real-valued vector of the first word of the word pair to produce a directional vector for the word pair; and
averaging the directional vectors computed for the word pairs of said plurality of word pairs to produce said directional vector representing said relational similarity standard.

16. The process of claim 15, wherein the process action of applying the relational similarity standard model to the inputted word pair to produce said relational similarity indicator, comprises the actions of:
applying the pre-trained semantic vector space model to each of the words of the inputted word pair whose relational similarity to the relational similarity standard is to be measured to produce a real-valued vector for each word;
computing a difference between the real-valued vector of the second word of said inputted word pair and the real-valued vector of the first word of said inputted word pair to produce a directional vector for the inputted word pair;
computing a distance measure between the directional vector computed for the inputted word pair and the directional vector representing said relational similarity standard; and
designating the computed distance measure to be the relational similarity indicator.

17. A computer-implemented process for measuring the degree of relational similarity between two pairs of words, each pair of which exhibits a semantic or syntactic relation between the words of the word pair, comprising:
using a computer to perform the following process actions:
inputting a pre-trained semantic vector space model, where each word associated with the model is represented as a real-valued vector;
applying the pre-trained semantic vector space model to each of the words of each word pair to produce a real-valued vector for each word thereof;
for each word pair, computing a difference between the real-valued vector of the second word of the word pair and the real-valued vector of the first word of the word pair to produce a directional vector for the word pair;
computing a directional similarity score using the directional vectors of the two word pairs; and
designating the directional similarity score to be the measure of the degree of relational similarity between the two word pairs.

18. The process of claim 17, wherein the process action of computing a directional similarity score using the directional vectors of the two word pairs, comprises computing a distance measure between the directional vectors produced for the two word pairs.

19. The process of claim 17, wherein the process action of inputting a pre-trained semantic vector space model, comprises inputting one of:
a distributed representation model derived from a word co-occurrence matrix and a low-rank approximation; or
a latent semantic analysis (LSA) model; or
a word clustering model; or
a neural-network language model.

20. The process of claim 17, wherein the process action of inputting a pre-trained semantic vector space model, comprises inputting a recurrent neural network language model (RNNLM).
